(19) United States
(12) Patent Application Publication
(10) Pub. No.: US 2002/0119246 A1
(43) Pub. Date: Aug. 29, 2002

(54) Method for producing color filter

(76) Inventors: Junichi Sakamoto, Yokohama-shi (JP); Nagato Osano, Kawasaki-shi (JP); Kenichi Iwata, Tokyo (JP); Satoshi Kokubo, Kawasaki-shi (JP)

Correspondence Address: FITZPATRICK CELLA HARPER & SCINTO, 30 ROCKEFELLER PLAZA, NEW YORK, NY, 10112, US

(21) Appl. No.: 09/468,865

(22) Filed: Dec. 21, 1999

(30) Foreign Application Priority Data
Dec. 25, 1998 (JP) 10-369264

(51) Int. Cl. B05D 5/06; B05D 1/32

(52) U.S. Cl. 427/64; 427/164; 427/165; 427/282

(57) ABSTRACT

There is provided a method for producing a color filter by coating a coating material on a substrate, wherein the coating material is coated only in an effective area on the substrate.

### BACKGROUND OF THE INVENTION

1. Field of the Invention

The present invention relates to a method for producing a color filter adapted for use in a color television, a personal computer or the like.

2. Related Background Art

In producing a color filter by coating a substrate with a coating material by a spin coater, the coating material after coating thereof is removed from the peripheral portion of the substrate.

Conventionally, as disclosed in the Japanese Patent Application Laid-Open No. 8-264923, the processing of the peripheral portion is conducted by washing, with an organic solvent or the like, the peripheral portion of the spin-coated substrate. However such method requires not only another apparatus such as an end face processing apparatus but also another process step, thereby elevating the production cost of the color filter and deteriorating the production yield.

Coating with a slit coater, as disclosed in the Japanese Patent Application Laid-Open No. 9-187710 executes coating of the material, leaving the end portions in a frame shape, so that the end face processing mentioned above becomes unnecessary. However, in case of cutting the substrate after color filter formation to obtain the color filter of a predetermined size, the material is wasted because the coated film is formed also on the surface of the unnecessary portions after cutting. Also in case of further processing the cut-off glass, certain coated materials may generate gas that is detrimental to the environment. Also in case of multi-layered configuration, the cross sections of the constituent layers are exposed on the cut face, so that the obtained product may become defective if any of the layers is inferior in durability.

In addition, in constructing the color filter into a display panel, it is necessary to another the liquid crystal driving substrate and the color filter substrate In this operation, the ordinary adhesive shows strong adhesion to the glass but weak adhesion to the organic film such as the protective layer. For this reason, the Japanese Patent Application Laid-Open No. 6-109920 discloses a method of polishing an area to be sealed, thereby eliminating the remainder of the photosensitive resin. However, this method not only causes waste of the material but also is difficult to apply to a color filter employing a water-soluble substance such as dye, since water is used in the polishing operation.

### SUMMARY OF THE INVENTION

In consideration of the drawbacks in the conventional technologies mentioned above, the object of the present invention is to achieve reduction of the material cost of the color filter, improvement in the durability thereof and to avoid environmental contamination.

The above-mentioned object can be attained, according to the present invention, by a color filter producing method by coating a coating material on a substrate, wherein the coating material is coated only in an effective area on the substrate.

In such method, in which the coating material is coated only in the effective area, there is not required, in the formation of a panel or in the cutting process, a step of eliminating the coating material deposited on the area to be adhered, and the waste of the material can be avoided. Also in case of a color filter consisting of plural layers, the sections of the constituent layers are not exposed on the cut face at the scribing operation, so that the durability of the color filter can be improved.

### BRIEF DESCRIPTION OF THE DRAWINGS

FIG. 1 is a cross-sectional view showing an example of the color filter to be produced by the color filter producing method of the present invention;

FIG. 2 is a process flow chart showing an example of the manufacturing process for the color filter shown in FIG. 1;

FIGS. 3A and 3B are views showing an example of the coating method to be employed in the color filter producing method of the present invention;

FIG. 4 is a view showing an example of the black matrix to be employed as a reference mask in the present invention;

FIG. 5 is a schematic view showing an example of the slit coater to be employed in the present invention;

FIG. 6A is a view showing an example of the configuration of the coating head to be employed in the present invention;

FIG. 6B is an elevation view of a spacer;

FIG. 7 is a plan view showing 4-panel arrangement in an example 3; and

FIG. 8 is a plan view showing the coating area in the example 3.

### DETAILED DESCRIPTION OF THE PREFERRED EMBODIMENTS

The aforementioned object can be attained by an embodiment of the present invention that is featured, in a step of coating a coating material such as pigment-dispersed color resist or material for the protective layer on a glass substrate on which formed is a black matrix composed of a metal such as chromium or of a resinous material, or in a step of coating resinous black matrix resist on a substrate, by a fact that such coating material is coated only in an effective area on the substrate.

The effective area means a portion which is to be used afterwards as the color filter, for example a portion where the black matrix is formed, or an internal area of each section divided by reference marks (scribe marks) for cutting the substrate.

The coating material is preferably coated with a slit coater. The coating is executed by discriminating the effective area of the substrate, by providing the coating head with an image recognizing mechanism and recognizing the reference marks. The reference mark can be composed of an alignment mark on the substrate or an edge of the black matrix pattern thereon.

The image recognizing mechanism mentioned above is provided in the advancing direction of the slit, in the relative moving direction between the slit coater and the substrate.

The slit coater can determine the presence or absence of the coated film in the coating (advancing) direction by the adjustment of the gap between the slit and the substrate. Also the presence or absence of the coated film transversal to the coating direction can be determined by the shape of the slit.

In the following there will be given a detailed description on the embodiment of the present invention.

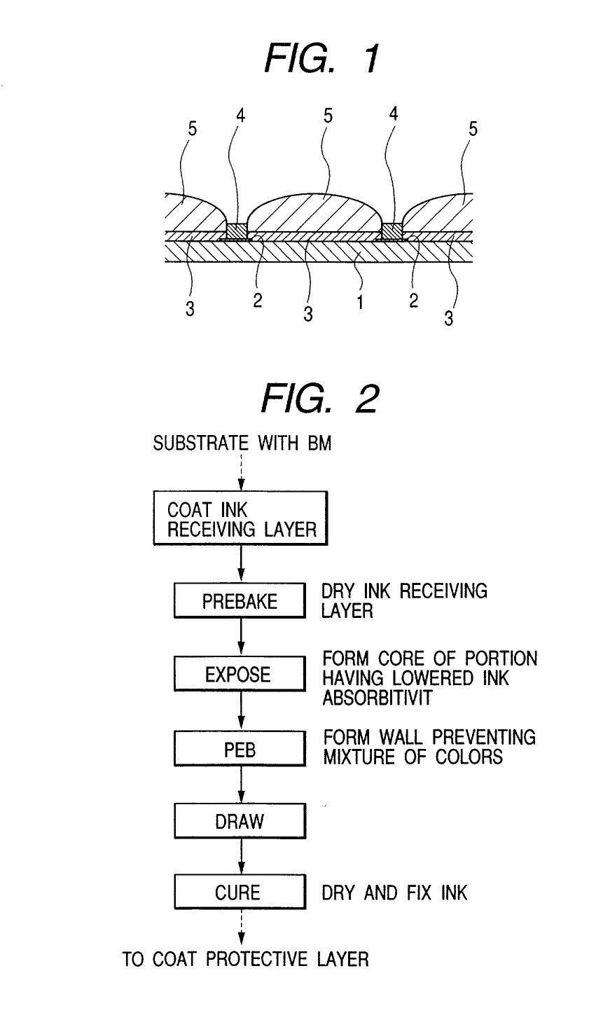

FIG. 1 is a schematic cross-sectional view of a color filter constituting a preferred embodiment of the present invention, wherein shown are a glass substrate 1, a black matrix (non-image area) 2, a resin layer (ink receiving layer) 3, a color mixing preventive layer 4, and ink 5. The ink 5 eventually penetrates into the resin layer, thereby dyeing the same.

FIG. 2 is a process flow chart showing the manufacture of the color filter shown in FIG. 1. At first, on a transparent substrate 1 such as of glass, a black matrix (BM) 2 is formed with a resinous material in which black pigment is dispersed or a metal such as chromium, utilizing photolithographic technology. The transparent substrate may also be composed of a plastic material. Then a predetermined resinous composition is coated and prebaked if necessary to form a resin layer. The above-mentioned resinous composition can be cured or denatured by light irradiation or by light irradiation combined with heating, and shows an ink receiving property which is lowered depending on the level of curing or denaturing. For example it can be composed of acrylic resin, epoxy resin, silicone resin or a cellulose derivative such as hydroxypropyl cellulose, hydroxyethyl cellulose, methyl cellulose or carboxymethyl cellulose, or a denatured product thereof.

Then the resin layer is pattern exposed through a photomask and is partially cured by heating (post-exposure bake), thereby forming the color mixing preventive wall 4. The unexposed portion (uncured portion) constitutes the ink receiving layer 3.

Then inks of R, G and B colors are deposited, by means of an ink jet head, on the ink receiving layer 3 constituting respective pixels, whereby a state shown in FIG. 1 is attained. Then the inks are dried and fixed, and a protectively layer (not shown) is coated if necessary, to complete the color filter.

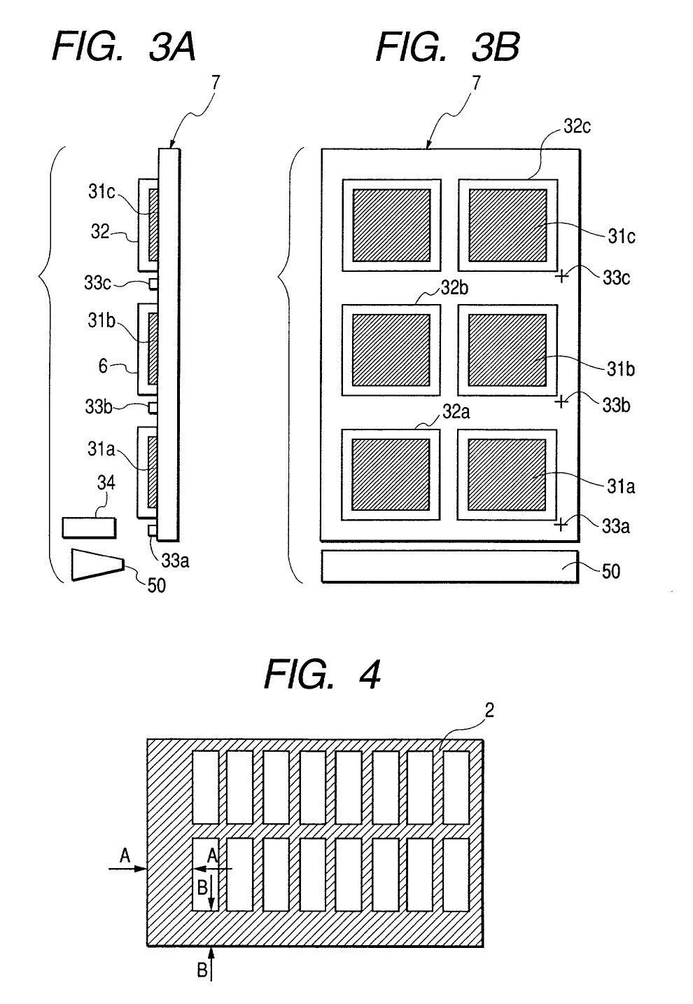

In general, plural color filter panels are cut from a single substrate. According to the present invention, the coating material such as the ink receiving layer is deposited in the area constituting the color filter, but is not coated in the portion to be scribed for cutting. More specifically, as shown in FIGS. 3A and 3B, color filters 31a, 31b, 31c and protective layers 32a, 32b, 32c are formed only in the effective area. The present invention is also applicable in case of coating the resist for forming the black matrix 2.

In the foregoing description, the color filter is formed by at first forming the ink receiving layer and then coloring the ink receiving layer with the ink, but the color filter may also be formed by depositing curable ink by the ink jet method in the aperture of the black matrix without the ink receiving layer and curing the curable ink in such aperture.

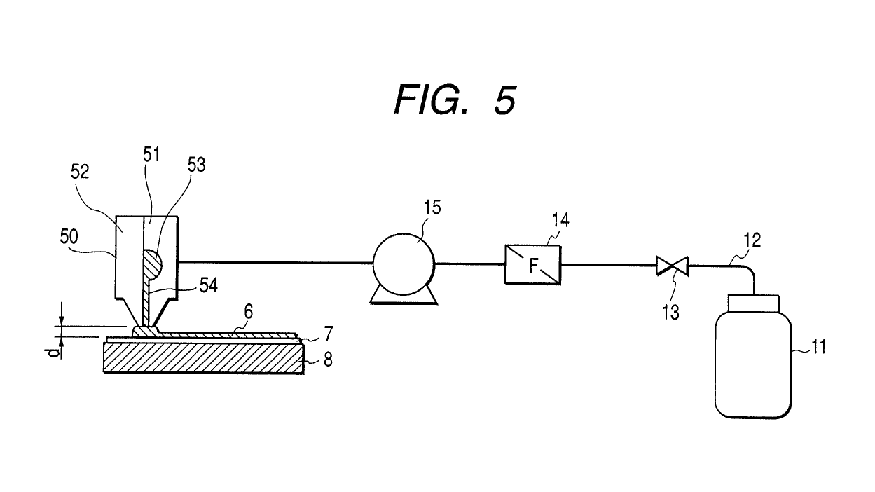

FIG. 5 shows the configuration of a slit coater that can be advantageously employed in executing the coating method of the present invention. Coating liquid is supplied from a liquid tank 11 by a constant rate pump 15 to a coating head 50. The constant rate pump means a volumetric pump such as a gear pump, a diaphragm pump or a syringe pump. For supplying the coating liquid there may also be employed, instead of such pump, a method of placing the liquid tank in a pressurizing container and supplying pressurized gas (air, nitrogen etc.) to such pressurizing container, thereby expelling the liquid from the tank.

In the piping 12 from the liquid tank 11 to the constant rate pump 15, there may be provided a valve 13 and a filter 14 according to the necessity.

The coating head 50, consisting of a front lip 51 and a rear lip 52, there are provided a coating liquid supply aperture and a manifold 53 for realizing a uniform pressure distribution in the coating liquid while it flows from the supply aperture to a coating slit 54. The gap of the slit 54 (distance between the front lip 51 and the rear lip 52) is preferably in a range of 10 to 20 μm.

At the coating operation, the coating head 50 is positioned opposed to a substrate 7 to be coated, with a predetermined distance (clearance) d thereto. The clearance d is preferably within a range of 500 μm to 20 μm.

The substrate is placed on a flat conveying stage 8 and is fixed thereto by vacuum suction in order to avoid displacement during the coating operation.

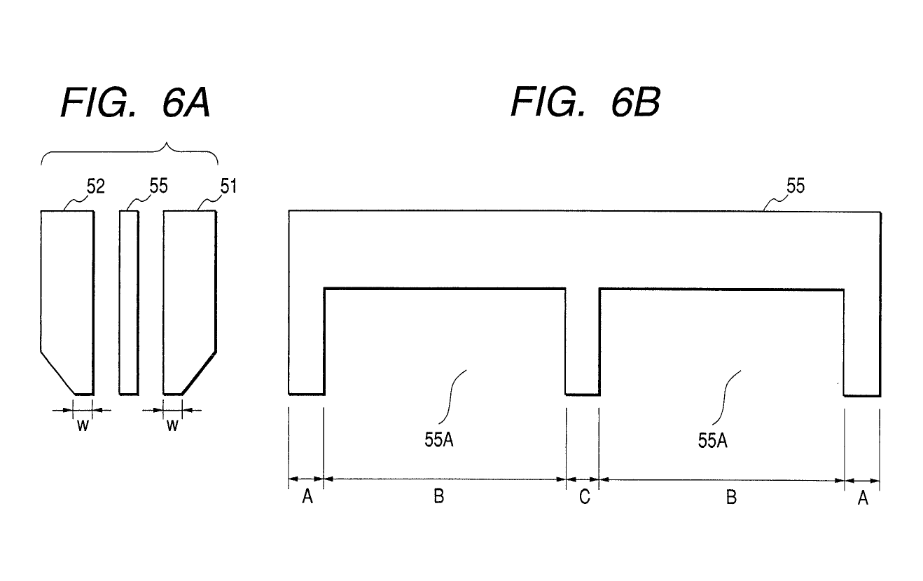

As shown in FIGS. 6A and 6B, the slit gap is formed by a shim 55 provided between the front lip 51 and the rear lip 52. The shim 55 is provided with notches 55A constituting the slit gap, and the width B of the notch 55A defines the coating width.

When the substrate 7 is loaded on the conveying stage 8 shown in FIG. 5, the supply of the coating liquid is started from the constant rate pump 15 to the coating head 50, and the coating head 50 or the conveying stage 8 is parallel moved immediately or after a predetermined time. After an image observation system 34 shown in FIGS. 3A and 3B detects a first alignment mark 33a on the substrate 7, the conveying stage 8 moves a predetermined distance, and, when the coating head 50 reaches a coating start position, the coating head 50 is lowered to a predetermined clearance position to start the coating of the protective layer 32a for the color filter 31a of the first row. When the conveying stage 8 has moved over a predetermined coating distance after the start of the coating, the coating head 50 is lifted to interrupt the coating. Then, after the detection of a second alignment mark 33b, the protective layer 32b for the color filter of the second row is coated in a similar manner, and the protective layer 32c of the color filter 31c of the third row is then coated in a similar manner. After the end of coating of the third row, the supply of the coating liquid from the constant rate pump 15 is terminated, and the coating head 50 is lifted at the same time while the conveying stage 8 is moved to a substrate transfer position. In this manner the protective layer (coated film 6) of a uniform coating thickness distribution is applied only in the effective area. The slit of the coating head 50 is closed at the center and at the both ends, in order that the coating is executed only in the width of the protective layer of each row.

In the foregoing description, the effective area is identified by detecting the alignment mark with the image observation system 34, but it may also be identified by detecting an edge of the black matrix pattern as shown in FIG. 4. For example the head 50 or the stage 8 is controlled by detecting the position of the corners of the black matrix 2, taking the center lines of the frames A-A and B-B of the black matrix 2 as reference lines.

The coating material is thus applied only in the effective areas of the substrate as shown in FIGS. 3A and 3B, and the color filter panels are obtained by cutting in areas other than the effective areas. Six color filter panels are obtained in the example shown in FIGS. 3A and 3B.

In the following the present invention will be explained further with examples.

### EXAMPLE 1

A thermo-curable resinous composition consisting of epoxy polymer Optomer SS0699G supplied by Japan Synthetic Rubber Co. was employed as the coating material, while a alkali-free glass substrate (1737 supplied by Corning Glass Co.) having a size of 550×650×0.7 mm and bearing thereon a chromium matrix with cross-shaped alignment marks and a color filter formed by ink jet method was employed as the substrate to be coated, and the coating was executed with a slit gap of 50 μm and a clearance of 75 μm. The substrate with the chromium matrix was so patterned as to provide six color filter panels of a display size of 12.1 inches. The constant rate pump 15 was composed of a diaphragm pump.

The substrate conveying stage 8 was driven with a high precision servo motor. The above-mentioned coating material for overcoat was charged in the liquid tank 11, and the liquid path to the coating slit was filled in advance with the coating liquid. The widths w (FIG. 6A) on the front lip and the rear lip were both selected as 0.5 mm.

The image observation system 35 was made to automatically recognize the alignment marks 33 (33a to 33b) in advance, thereby memorizing the coating start position. The thermo-curable resin was coated by moving the substrate 7 to such start position.

The coating was executed with a substrate conveying speed of 12 mm/sec and a liquid discharge rate of 32.8 μl/sec, in such a manner that the coating start point and the coating end point were 1 mm inside the edges of the substrate.

After the coating of the black matrix corresponding to the display size of 12.1″, the coating head was lifted upwards and the second alignment mark 22b was recognized.

The above-described steps were repeated, and, after the coating of the third black matrix area 31c, the coated substrate was baked for 20 minutes at 90° C. to obtained the desired coated film.

### EXAMPLE 2

Resinous black resist BK-739P supplied by Shin-Nittetsu Chemical Co. was employed as the coating material, while a alkali-free glass substrate (1737 supplied by Corning Glass Co.) having a size of 550×650×0.7 mm was employed as the substrate to be coated, and the coating was executed with a slit gap of 50 μm and a clearance of 75 μm.

The coating areas were memorized in advance corresponding to an arrangement of six color filter panels of a display size of 12.1″, and the coating was executed only in the area of black matrix by lowering the coating head 5 close to the substrate only in the coating area and lifting the coating head 5 upwards in the non-coating area.

The substrate with the black matrix was obtained thereafter through steps of drying, exposure and development.

### EXAMPLE 3

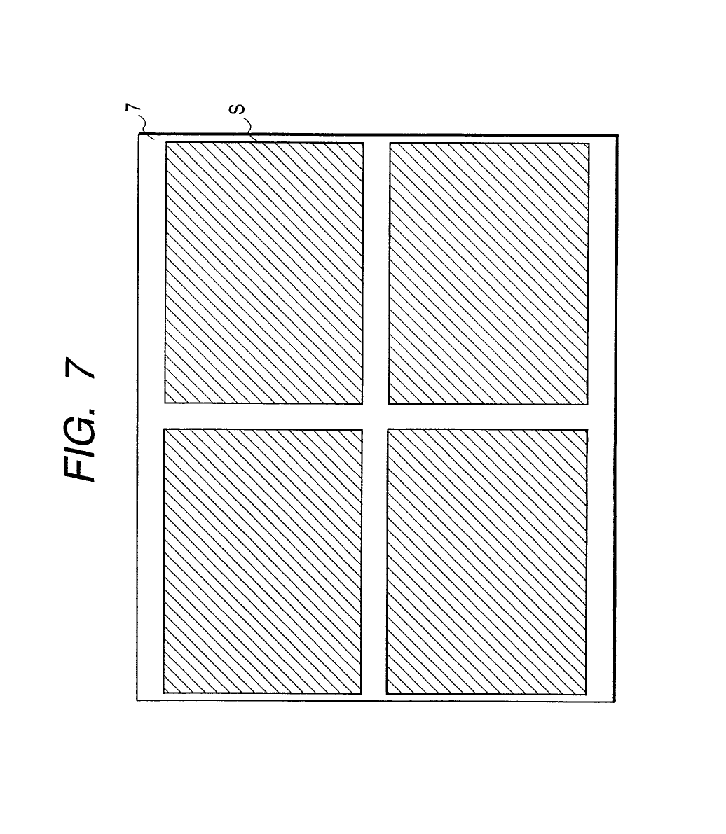

In this example, all the organic layers constituting the color filter were prepared with the method of the present invention. There was employed a substrate of a size of 550×650×0.7 mm, and four color filter panels of a display size S of 14.5 inches were arranged on the substrate as shown in FIG. 7.

The forming conditions for the layers are shown in Table 1.

The valve 13 shown in FIG. 5 was turned off when the clearance d was 2 mm, and was turned on when the clearance d was 0.05 mm.

The black resist layer was formed on an alkali-free glass substrate (#1737 supplied by Cornining Glass Inc.) of a size of 550×650×0.7 mm, according to the conditions shown in Table 1. The substrate with the black resist was subjected to the steps of drying (on a hot plate of 120° C. for 120 seconds), exposure (proxy gap 150 μm, 400 mJ/cm²) and development (by showering with developer CD (supplied by Fujifilm Olin Co.) of 20 vol. % at 24° C. for 80 seconds) to obtain a substrate with black matrix.

Then, on the above-mentioned substrate with black matrix, the receiving layer was formed according to the conditions shown in Table 1. The substrate coated with the receiving layer was subjected to the steps of drying (on a hot plate of 50° C. for 180 seconds), exposure (proxy gap 100 μm, 60 mJ/cm²) and post-exposure bake (on a hot plate of 110° C. for 90 seconds), and R, G and B colored areas were formed by the ink jet method to obtain a colored substrate.

Then a protective layer was formed on the colored substrate, according to the conditions shown in Table 1. The substrate after coating of the protective layer was subjected to the steps of drying (on a hot plate of 90° C., 180 seconds) and curing (on a hot plate of 230° C., 5 minutes) to obtain a color filter.

The color filter thus obtained was easy to cut, without generation of particles from the organic coated layers on the surface, since the glass was directly cut in the succeeding scribing step. The color filter was also excellent in moisture resistance since the coated film was not exposed on the section.

According to the present invention, as explained in the foregoing, the coating material is coated only in the effective area, thereby allowing to reduce the material cost. Also the durability can be improved since the protective layer is not cut in the scribing step.

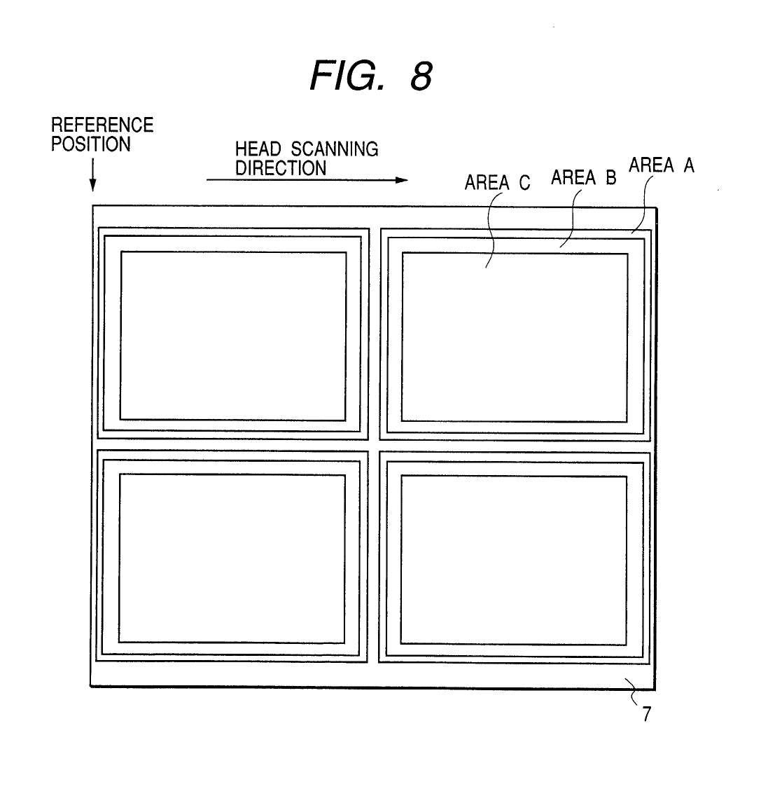

TABLE 1

| Layer | black resist | | ink receiving | | protective | |
|---|---|---|---|---|---|---|
| (area in FIG. 8) | layer | | layer | | layer | |
| | (area A) | | (area C) | | (area B) | |
| Coating | black resist | | CF13S (Seiko | | Optomer | |
| material | CK-S171X | | Chemical) | | SS6699G (JSR) | |
| | (Fujifilm Olin) | | | | | |
| Material supply | 45 | | 80 | | 75 | |
| pressure (kPa) | | | | | | |
| Shim | 20 | | 30 | | 30 | |
| thickness | | | | | | |
| (l) | | | | | | |
| Coating | 80 | | 20 | | 50 | |
| speed | | | | | | |
| (mm/sec) | | | | | | |
| Shin shape | A = 23.5 | | A = 36 | | A = 33.5 | |
| (mm) | B = 247 | | B = 222 | | B = 227 | |
| A-C in FIG. 6 | C = 9 | | C = 34 | | C = 29 | |
| Distance l (mm) | l | d | l | d | l | d |
| of coating head l | 0-1 | 2 | 0-10 | 2 | 0-9 | 2 |
| from reference | 2-315 | 0.05 | 11-308 | 0.05 | 10-309 | 0.05 |
| position and | 316-333 | 2 | 309-340 | 2 | 310-339 | 2 |
| clearance d | 334-647 | 0.05 | 341-638 | 0.05 | 340-639 | 0.05 |
| (mm) | 648-650 | 2 | 639-650 | 2 | 640-650 | 2 |

What is claimed is:

1. A method for producing a color filter by coating a coating material on a substrate, wherein said coating material is coated only in an effective area on said substrate.

2. A method for producing a color filter according to claim 1, wherein said coating material is coated with a slit coater.

3. A method for producing a color filter according to claim 2, wherein the coating head of said slit coater is provided with an image recognizing mechanism for recognizing a reference mark, thereby identifying the effective area of said substrate.

4. A method for producing a color filter according to claim 3, wherein said reference mark is an alignment mark.

5. A method for producing a color filter according to claim 3, wherein said reference mark is an edge of a black matrix.

6. A method for producing a color filter according to claim 1, wherein the coloring of said color filter is executed by ink jet process.

7. A method for producing a color filter according to claim 2, wherein the coloring of said color filter is executed by ink jet process.

8. A method for producing a color filter according to claim 3, wherein the coloring of said color filter is executed by ink jet process.

9. A method for producing a color filter according to claim 4, wherein the coloring of said color filter is executed by ink jet process.

10. A method for producing a color filter according to claim 5, wherein the coloring of said color filter is executed by ink jet process.
